(19) United States
(12) Patent Application Publication
(10) Pub. No.: US 2008/0056290 A1
(43) Pub. Date: Mar. 6, 2008

(54) CONTROLLING THE DATA-PACKET TRANSMIT INTERVAL OF NETWORK DEPENDENT APPLICATIONS (NDA)USING DEVICE DRIVER FEEDBACK

(76) Inventors: NIKHIL HEGDE, Austin, TX (US); RASHMI NARASIMHAN, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/470,467

(22) Filed: Sep. 6, 2006

(51) Int. Cl. H04L 12/56

(52) U.S. Cl. 370/412; 370/235

(57) ABSTRACT

A method, system and computer program product for dynamically determining an optimal inter-packet transmit interval of a network-dependent application (NDA) in a data processing system by utilizing feedback from the network device driver is presented. Specifically, a Network Driver Feedback (NDF) utility allows an NDA to reduce the inter-packet transmit interval (sleep time) by utilizing feedback of the amount of data in the transmit queue of the network device driver. The NDF utility directs the network device driver to update a variable representing the amount of data in the transmit queue of the network device driver. The value of this updated variable is returned as feedback to the NDA. The NDA then determines the NDA sleep time, and the NDA suspends its packet transmit process until the sleep time expires. At the end of the sleep time, the NDA attempts to re-transmit data. Ultimately, the NDF utility allows NDAs to efficiently transmit data while maintaining a sustained and high-speed data flow from the NDA to the physical link.

### BACKGROUND OF THE INVENTION

1. Technical Field

The present invention generally relates to data processing systems and in particular to data packet transmission from a data processing network. Still more particularly, the present invention relates to the data packet transmit interval of network dependent applications from a data processing system.

2. Description of the Related Art

The performance of most network-dependent applications (NDAs) is directly linked to the rate at which data flows from a source device to a destination device. This flow can be broadly divided into three sections: (1) source NDA to the source network access device (e.g., a network adapter); (2) source network access device to the destination network access device; and finally (3) destination network access device to the destination NDA.

With today's high performance data processors, it is quite likely that many data processing systems are equipped with a very powerful central processing unit (CPU) but have a relatively slower network adapter. Consequently, during transmission, there is a possibility that data from an NDA may be queued to the network adapter at a much higher rate than the rate at which that data is sent out to the network via a network adapter. This condition results in a bottleneck at the network adapter. The occurrence of such bottlenecks is especially true for User Datagram Protocol (UDP)-based applications which have to implement their own flow-control. In the case of Transmission Control Protocol (TCP) applications, the TCP layer will only queue a TCP window worth of data. Thus, in TCP applications, this queuing of a fixed window of data acts as a natural flow-control mechanism, and the above bottleneck condition may not occur. However, when TCP data segmentation is offloaded to the source network access device, the above bottleneck condition may still occur.

NDAs typically use the error value returned by the packet transmit routine to police the flow of data to the associated network access device. The transmit routines return an error if the datagram being transmitted by an NDA is unable to find enough space in the network device driver's transmit queue to hold the datagram. When the transmit routine returns an error, the application “sleeps” for some time and then tries to re-transmit data. The duration of this “sleep time”, i.e., the inter-packet transmit interval, is an empirically determined value. Furthermore, once this value is set based on test runs, there is no real way to dynamically modify this value at runtime. As a result, the NDA will actually transmit data to the network device driver at a rate which is below the capacity that the network device driver can handle. Thus the performance of the NDA suffers.

Considering the inefficiencies involved in data transfer from an NDA to the network device driver, the present invention recognizes that it would be beneficial to substantially reduce this bottleneck issue.

### SUMMARY OF THE INVENTION

Disclosed is a method, system and computer program product for dynamically determining an optimal inter-packet transmit interval of a network-dependent application (NDA) in a data processing system by utilizing feedback from the network device driver. Specifically, a Network Driver Feedback (NDF) utility allows an NDA to reduce the inter-packet transmit interval (sleep time) by utilizing feedback of the amount of data in the transmit queue of the network device driver. The NDF utility directs the network device driver to update a variable representing the amount of data in the transmit queue of the network device driver. The value of this updated variable is returned as feedback to the NDA. The NDA then determines the NDA sleep time, and the NDA suspends its packet transmit process until the sleep time expires. At the end of the sleep time, the NDA attempts to re-transmit data.

In one embodiment based on the feedback provided to the NDF utility, NDF utility triggers the NDA to adjust the size of a datagram to make best use of the available space on the network device driver's transmit queue. Furthermore, when a number of NDAs are concurrently vying to transmit data using the network device driver, NDF utility may assign priorities to various NDAs such that the high priority NDAs may be more aggressive in the transfer of data than the lower priority NDAs. Thus, higher priority NDAs may transfer data before the lower priority NDAs. Consequently, the NDF utility provides prioritized, dynamic flow control (i.e., scheduling of datagrams) between each of the NDAs and the network device driver. Ultimately, the NDF utility allows NDAs to efficiently transmit data while maintaining a sustained and high-speed data flow from the NDA to the physical link.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a data processing system within which the features of an illustrative embodiment may be advantageously implemented;

FIG. 2 is block diagram of the network driver feedback system, according to the described embodiments; and

FIG. 3 is a flow-chart illustrating the process completed by the network driver feedback system, according to an illustrative embodiment.

### DETAILED DESCRIPTION OF AN ILLUSTRATIVE EMBODIMENT

The present invention provides a method, system and computer program product for dynamically determining an optimal inter-packet transmit interval of a network-dependent application (NDA) in a. data processing system by utilizing feedback from the network device driver. Specifically, a Network Driver Feedback (NDF) utility allows an NDA to reduce the inter-packet transmit interval (sleep time) by utilizing feedback of the amount of data in the transmit queue of the network device driver. The NDF utility directs the network device driver to update a variable representing the amount of data in the transmit queue of the network device driver. The value of this updated variable is returned as feedback to the NDA. The NDA then determines the NDA sleep time, and the NDA suspends its packet transmit process until the sleep time expires. At the end of the sleep time, the NDA attempts to re-transmit data.

In one embodiment based on the feedback provided to the NDF utility, NDF utility triggers the NDA to adjust the size of a datagram to make best use of the available space on the network device driver's transmit queue. Furthermore, when a number of NDAs are concurrently vying to transmit data using the network device driver, NDF utility may assign priorities to various NDAs such that the high priority NDAs may be more aggressive in the transfer of data than the lower priority NDAs. Thus, higher priority NDAs may transfer data before the lower priority NDAs. Consequently, the NDF utility provides prioritized, dynamic flow control (i.e., scheduling of datagrams) between each of the NDAs and the network device driver. Ultimately, the NDF utility allows NDAs to efficiently transmit data while maintaining a sustained and high-speed data flow from the NDA to the physical link.

In the following detailed description of illustrative embodiments of the invention, specific illustrative embodiments by which the invention is practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

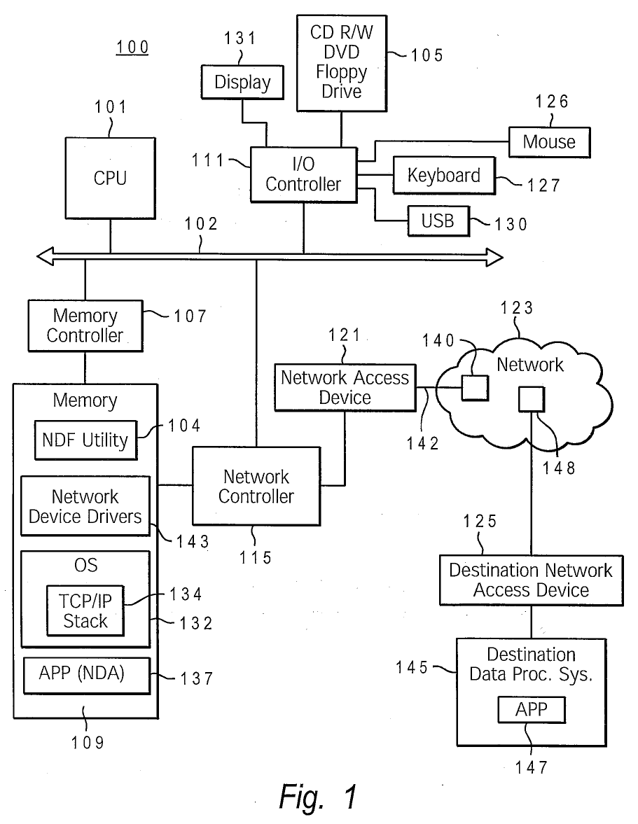

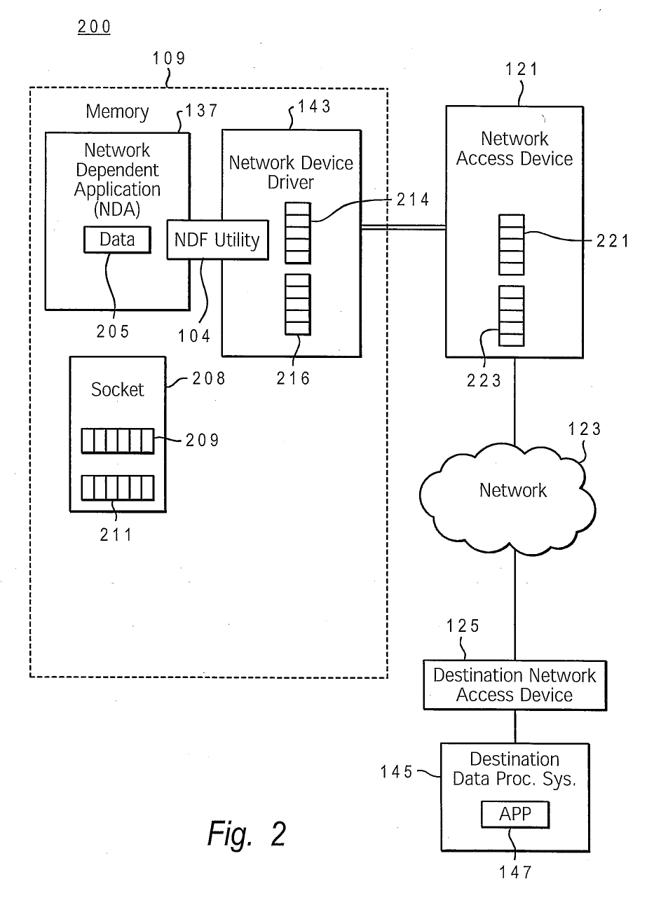

Within the descriptions of the figures, similar elements are provided similar names and reference numerals as those of the previous figure(s). Where a later figure utilizes the element in a different context or with different functionality, the element is provided a different leading numeral representative of the figure number (e.g, 1xx for FIG. 1 and 2xx for FIG. 2). The specific numerals assigned to the elements are provided solely to aid in the description and not meant to imply any limitations (structural or functional) on the invention.

It is also understood that the use of specific parameter names are for example only and not meant to imply any limitations on the invention. The invention may thus be implemented with different nomenclature/terminology utilized to describe the parameters, without limitation.

With reference now to the figures, FIG. 1 depicts a data processing system within which features of the invention may be advantageously implemented. Data processing system (DPS) 100 comprises central processing unit (CPU) 101 coupled to system bus/interconnect 102. Also coupled to system bus/interconnect 102 is memory controller 107 which controls access to memory 109. System bus 102 is coupled to input/output controller (I/O Controller) 111, which controls access to/from several input devices, of which mouse 126 and keyboard 127 are illustrated. I/O Controller 111 also controls access to output devices, of which display 131 is illustrated. In order to support use of removable storage media, I/O Controller 111 may further support one or more USB ports 130 and one or more drives 105 for media, such as compact disk Read/Write (CDRW), digital video disk (DVD), and Floppy disk, for example.

DPS 100 further comprises network access device 121 by which DPS 100 is able to connect to and communicate with an external device or network (such as the Internet or network 123) via wired or wireless connection 142. Network access device 121 may be a modem or network adapter and may also be a wireless transceiver device.

Those of ordinary skill in the art will appreciate that the hardware depicted in FIG. 1 may vary. For example, other peripheral devices, such as optical disk drives and the like, also may be used in addition to or in place of the hardware depicted. Thus, the depicted example is not meant to imply architectural limitations with respect to the present invention. The data processing system depicted in FIG. 1 may be, for example, an IBM eServer pSeries system, a product of International Business Machines Corporation in Armonk, N.Y., running the Advanced Interactive Executive (AIX) operating system or LINUX operating system.

Various features of the invention are provided as software code stored within memory 109 or other storage and executed by processor(s) 101. Among the software code are code for implementing an NDA, code for enabling network connection and communication via network access device 121 and associated device driver, and more specific to the invention, code for enabling the network driver feedback features described below. For simplicity, the collective body of code that enables the network driver feedback features is referred to herein as Network Driver Feedback (NDF) utility 104. In actual implementation, NDF utility 104 may be added to existing operating system (OS) code to provide the network driver feedback functionality described below.

Thus, as shown by FIG. 1, in addition to the above described hardware components, data processing system 100 farther comprises a number of software components, including operating system (OS) 132 (e.g., Microsoft Windows®, a trademark of Microsoft Corp, or GNU®/Linux®, registered trademarks of the Free Software Foundation and The Linux Mark Institute) and one or more software applications, including NDA 137 and NDF utility 104. In implementation, OS 132, NDA 137 and NDF utility 104 are loaded into memory 109 and executed on processor (CPU) 101. Furthermore, NDA 137 may, for example, use the User Datagram Protocol (UDP) in TCP/IP stack 134, residing in OS 132, in order to transmit data across Network 123. According to the illustrative embodiment, when processor 101 executes NDA 137 and NDF utility 104, NDF utility 104 enables data processing system 100 to complete a series of functional processes, including: (1) initiating a request for feedback of the amount of data in the transmit queue of Network Device Driver 143; (2) determining watermarks (defined below); (3) periodically updating a variable representing the amount of data in the transmit queue of Network Device Driver 143; (4) determining NDA “sleep” time or inter-packet transmit interval based on feedback of the queue status; (5) assigning data transfer priorities to various NDAs that may be using DPS 100; and other features/functionality described below and illustrated by FIGS. 1-3.

In the described embodiment, NDF utility 104 integrates additional software into NDA in order to include some of the functions of NDF utility 104 within NDA 137. Similarly, NDF utility 104 also integrates some of the functions of NDF utility 104 into network device driver 143. Thus, some of the intelligent functions of NDF utility 104 are distributed among NDA 137 and network device driver 143. The resulting distributed form of NDF utility 104 also allows specific items to be included in the set of functions carried out by NDA 137 and/or device driver 143. Among these functions are: (1) requests issued by NDA 137; (2) feedback returned to NDA 137 by network device driver 143; and (3) updates to variables by network device driver 143, each of which are described in detail below. Thus, the results of executing distributed functions of NDF utility 104 which are directly observed by NDA 137 or network device driver 143 are also simultaneously observed by NDF utility 104. This method of integrating functions of NDF utility 104 into NDA 137 and network device driver 143 increases the efficiency of NDF utility 104.

In an alternate embodiment, NDF utility 104, NDA 137 and network device driver 143 may be regarded as (completely or essentially) separate entities. In this case, NDF utility 104 communicates directly with NDA 137 and with network device driver 143 and receives results of the execution of certain requests and/or functions directly from NDA 137 and from network device driver 143.

In the described embodiment, NDA 137 issues a request for feedback about the amount of data in the transmit queue of network device driver 143. NDA 137 periodically issues an “ioctl” feedback request to network device driver 143 to retrieve information about the amount of data in the transmit queue of network device driver 143. An “ioctl” (acronym for Input/Output Control) is a system call, which allows an application such as NDA 137 to control or communicate with a device driver, such as network device driver 143, outside the usual read/write data operations. Network device driver 143 then returns feedback of the amount of data in the transmit queue. NDA 137 then utilizes this information about the current amount of data in the transmit queue to determine the sleep time for NDA 137 before attempting to re-transmit data.

In order to facilitate further explanation of the described embodiment, reference is now made to FIG. 2. FIG. 2 is a block diagram illustrating components of the network device feedback system, according to the described embodiment. Feedback system 200 comprises NDA 137 and Network Device Driver 143 both residing in Memory 109. Also residing in memory 109 is Socket 208 which comprises two buffers, Send-Q 209 and Receive-Q 211.

In feedback system 200, when a call to the transmit routine is made by NDA 137, the data packet is queued to the transmit buffer, Send-Q 209, of socket 208. Network Device Driver 143 then transfers the packet from socket 208 to transmit queue 214 of Network Device Driver 143. The call to the transmit routine may fail for the following reasons: (1) there is not enough memory to hold the packet; or (2) there is no space left in the transmit queue of network device driver 143. The latter reason is likely in a system with a slow network adapter. If a data transfer call fails, the transmit routine returns a message indicating an error in the data transfer call. Once a data transfer call by NDA 137 fails, NDF utility 104 triggers the feedback function of NDF utility 104 to retrieve information about the amount of data in the transmit queue of network device driver.

When an error message is received, indicating a failure of a data transfer call by NDA 137, NDA 137 issues an “ioctl” to network device driver 143 to retrieve information about the amount of data in the transmit queue of network device driver. Information about the amount data in queue may also be retrieved by taking the absolute value of the return value of the sendto routine. The “sendto” is a routine used to send a message to a socket (defined herein as one endpoint of a two-way communication link between two programs running on the network). The return value of the sendto routine contains the value of the amount of data in the transmit queue of network device driver 143. For example, the return value could be: (1) 0, which indicates no error; or (2) less than 0, the absolute value of this number represents the amount of data in the transmit queue. Thus if there is an error, the absolute value of the return value of the sendto routine is equal to the amount of data in the transmit queue of network device driver 143.

In the illustrative embodiment, NDF utility 104 represents the (amount of data in the transmit queue) variable as “ndd_tx_que_length”. Network device driver 143 returns as feedback the value of ndd_tx_que_length to NDA 137 via Receive-Q buffer 111 of Socket 208. Furthermore, based on this feedback, NDA 137 then determines sleep time (described below) for NDA 137 before NDA 137 re-transmits data. After the sleep time expires, NDA 137 re-transmits data.

The criteria for determining the ideal sleep time (and similarly for determining ideal watermark) may include the following: (1) the current size of the datagram being issued by the NDA 137; (2) the full queue space of the network device driver 143; and (3) average data transmission rate. The current datagram size indicates to NDF utility 104 the minimum amount of transmit queue space that must be available for a datagram to be successfully transferred to the transmit queue. In addition, by knowing the full space of the transmit queue, NDF utility 104 determines the relative maximum amount of data in the transmit queue which would still allow a successful and immediate transfer of more data from NDA 137 into this transmit queue. This relative maximum amount of data in the transmit queue is determined by subtracting the current datagram size from the full queue space. Utilizing the average data transmission rate, NDF utility 104 is able to estimate the rate at which data is transferred from the queue to network access device 121. This means that a specific amount of sleep time also corresponds to an estimated amount of data that may be transferred to network access device 121 in that time interval. Consequently, NDF utility 104 is able to estimate the change in the amount of data in the transmit queue during sleep time. Therefore, the sleep time is calculated by factoring the feedback information about the current amount of data in the transmit queue of network device driver 143 and the estimated change in the amount of data in the transmit queue for the duration of sleep time. In addition, the calculation of sleep time factors the time it takes to receive feedback information and to determine sleep time.

In one embodiment, NDF utility 104 enables the NDA 137 to adjust the size of a datagram to make best use of the available space on the network device driver's transmit queue. This embodiment requires NDA 137 have the ability to break a normal size datagram into smaller sized packets and transmit these smaller sized packets. Thus, if the feedback (ndd_tx_que_length) indicates that the available space within the transmit queue is large enough to hold one or more of the smaller sized packets, NDF utility 104 triggers NDA 137 to break up the datagram into these smaller sized packets and immediately re-transmit these smaller sized packets. NDA 137 immediately sends lower priority data, if the lower priority data is small enough to fit into the available space. Breaking of normal packets into smaller sized packets may be limited to lower priority datagrams, and a sleep time is calculated for the re-transmission of the normal size datagram, taking the transmission of these smaller sized packets into consideration.

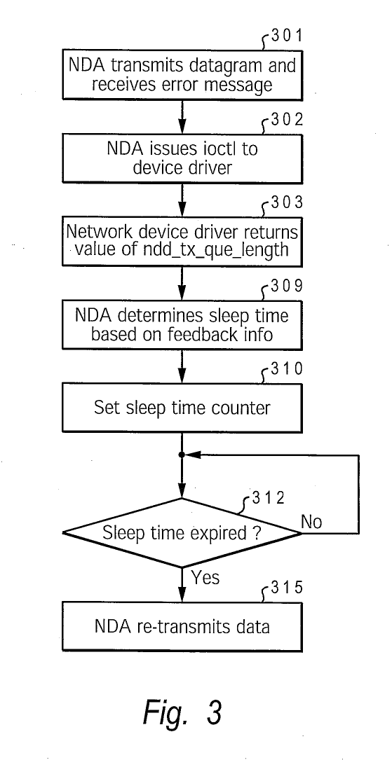

Referring again to the figures, FIG. 3 illustrates the process completed by the network driver feedback system, according to the described embodiment. The process begins at block 301, at which NDA 137 transmits a datagram and receives an error message. In response, NDA 137 issues an ioctl to network device driver 143, at block 302. At block 303, network device driver 143 returns the value of ndd_tx_que_length to NDA 137. Furthermore, NDA 137 then determines the sleep time for NDA 137 based on the value of ndd_tx_que_length, at block 309. NDA 137 sets the sleep time counter, as shown at block 310. At block 312, NDA 137 determines if sleep time has expired. If sleep time has not expired, the process returns to block 312. If the sleep time has expired, NDA 137 re-transmits data, as shown at block 315.

In an alternate embodiment, additional factors may be included in the criteria for determining the ideal watermark. Among these additional factors is the degree of non-uniformity in data transmission rates, for example. The degree of non-uniformity in data transmission rates is a measure of how close the various transmission rates are to the average. Whenever there are data processing systems with a large number of users and NDAs accessing various networks of various types, data transmission rates may vary significantly. Thus, these systems may be characterized by a high degree of non-uniformity in data transmission rates. Using statistical nomenclature, the degree of non-uniformity in data transmission rates may be called the “variance” of the data transmission rates. The variance in transmission rates is utilized to give NDF utility 104 an indication of the strength of the estimate associated with determining sleep time.

With diverse NDAs accessing diverse network types, the estimate provided by utilizing only the factors of the criteria (for assigning ideal sleep time) of the described embodiment may be further enhanced by including the variance factor. A high variance in data transmission rates corresponds to a certain level of uncertainty with respect to changes in the amount of data in the transmit queue during sleep time. As a consequence, NDF utility 104 may chose to minimize the uncertainty of changes in the amount of data in the transmit queue during a specific NDA's sleep time by establishing a low watermark value on which to base the sleep time determination. Determining the sleep time based on a low watermark value leads to less sleep time for the NDA. On the other hand, if the variance is low, a high degree of certainty in the estimate allows NDF utility 104 to establish a higher watermark value, or to simply use any feedback value of the amount of data in the transmit queue, on which to base the sleep time determination. Establishing a higher watermark value on which to base the sleep time determination indicates more sleep time for the NDA.

In one embodiment, in which a plurality of NDAs are vying for access to the network (transmit queue), NDF utility 104 may assign priorities by associating each NDA with a unique watermark. This assigning of unique watermarks effectively gives each NDA a unique transmission window. Thus, the NDAs transmit data when each NDA's unique watermark is crossed. Thus, the NDA may periodically (e.g. every one millisecond) check the amount of data in the transmit queue and store this information about the amount of data in the transmit queue in a variable. The variable which represents the length of the occupied transmit queue is updated each time interval, “TIMEINT”. This update occurs while the value of the variable remains above a preset (by NDF utility 104) watermark. In order to determine the ideal interval of time, TIMEINT, between successive updates of the amount of data in the transmit queue, NDF utility 104 uses criteria similar to the criteria for determining the ideal sleep time.

Referring still to one embodiment in which a plurality of NDAs are vying for access to the network (transmit queue), the criteria for determining watermarks are quite similar to the criteria for determining sleep time. The factors used in the sleep time criteria may be used in establishing watermark criteria. Thus, the priority of an NDA based only on the size of the NDA's datagram may be established using factor (1) of the criteria for determining the ideal sleep time, in the described embodiment. However, if the priority of the NDA now depends mostly on the data importance, the priority with respect to data importance of an NDA may be added to the criteria previously outlined in the described embodiment to form the criteria for assigning ideal watermarks. High priority applications should be allowed to re-transit datagrams before lower priority NDAs. Thus, lower priority NDAs are assigned higher watermarks (longer sleep time), and higher priority NDAs are assigned lower watermarks (shorter sleep time). The sleep time assigned the lower priority NDAs factors in an additional time to account for the earlier re-transmission of datagrams from the higher priority NDAs.

In the described embodiment, the criteria for determining the ideal sleep time (and watermark) associated with an NDA are not limited to the factors listed above. In particular, in alternate embodiments NDF utility 104 may choose a larger set of factors or a subset of the above factors in forming the criteria for the determining sleep times (or the watermarks) of NDAs.

In the flow chart (FIG. 3) above, while the process steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

By controlling the inter-packet transmit interval through dynamic network device driver feedback, the NDF utility gives network-dependent applications a performance increase. Applications are now able to transfer data at higher rates as sleep time is carefully calculated and reduced. Consequently, the NDF utility provides realistic and dynamic flow control between a network-dependent application and the network device driver.

As a final matter, it is important that while an illustrative embodiment of the present invention has been, and will continue to be, described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

While the invention has been particularly shown and described with reference to a apreferred embodiment, it will be understood by those skilled in the art that various changes in form and detail may be made therein without departing from the spirit and scope of the invention.

What is claimed is:

1. In a data processing system having a network dependent application (NDA) generating data packets for network transmission, a network adapter that enables transmission of said data packets to an external network, where said network adapter has an associated device driver and a transmit queue, a method comprising:
when a request from the NDA to the network adapter to transmit a data packet returns an error indicating the transmit queue of the network adaptor is full, generating an ioctl request and issuing said ioctl request to the network adapter, wherein said ioctl request triggers the network adapter to determine and return a value of a current available space within the transmit queue;
automatically determining a sleep time for the NDA based on the value of the current available space of the transmit queue and the rate at which the network adapter is currently transmitting data packets out of the transmit queue;
placing a data transmit function of the NDA in a sleep mode for a period of time equal to the sleep time; and
retransmitting the data packet from the NDA to the network adapter when the sleep time expires.

2. The method of claim 1, further comprising:
issuing a data transfer call to the network adapter via a transmit routine of the NDA;
monitoring for a return message indicating success or failure of the data transfer call; and
completing said generating of the ioctl only when the return message indicates an error of the data transfer call.

3. The method of claim 1, wherein said determining further comprises:
calculating an available space remaining in the transmit queue;
determining a current rate of evicting pending data packets from the transmit queue;
evaluating an amount of space necessary to receive the data packet from the NDA into the transmit queue; and
calculating the sleep time using the results of said calculating, determining and evaluating steps along with a transmit latency for transmitting the data packet from a socket of the NDA to the transmit queue of the network adapter.

4. The method of claim 3, further comprising:
determining if the available space within the transmit queue is large enough to hold a smaller data packet supported by the network adapter and the NDA;
when the available space within the transmit queue is large enough to hold a smaller data packet, breaking a low priority data packet into smaller data packets of similar size to the smaller data packet supported by the network adapter and the NDA;
immediately transmitting said smaller data packets to said transmit queue; and
adjusting the sleep time calculated for normal sized data packets to account for the transmission of said smaller data packets, wherein higher priority packets are held until expiration of the adjusted sleep time.

5. The method of claim 1, wherein said NDA is a first NDA and said data processing system comprise multiple NDAs, said method further comprising:
when at least one other NDA is actively transmitting data packets concurrently with the first NDA, calculating a unique sleep time for each of the active NDAs transmitting data packets, such that each active NDA sleeps for a different period of time to prevent conflicts when retransmitting their respective data packet(s) to the transmit queue.

6. The method of claim 5, further comprising:
prioritizing said active NDAs relative to each other based on application provided criteria and user defined criteria; and
calculating and assigning the unique sleep time based on a relative priority of the first NDA to the other NDA.

7. The method of claim 3, further comprising:
receiving a sendto routine from the network adapter's device driver, wherein said sendto routine includes the value of the currently available space within the transmit queue; and
periodically issuing a request for a return of said sendto routine to check the current value and adjust a new calculation of sleep time for a subsequent request to transmit data that results in an error.

8. A computer program product comprising:
a computer readable medium; and
program code on said computer readable medium that when executed within a data processing system having (a) a network dependent application (NDA) generating data packets for network transmission, (b) a network adapter that enables transmission of said data packets to an external network, where said network adapter has an associated device driver and a transmit queue, said program code provides the functionality of:
when a request from the NDA to the network adapter to transmit a data packet returns an error indicating the transmit queue of the network adaptor is full, generating an ioctl request and issuing said ioctl request to the network adapter, wherein said ioctl request triggers the network adapter to determine and return a value of a current available space within the transmit queue;
automatically determining a sleep time for the NDA based on the value of the current available space of the transmit queue and the rate at which the network adapter is currently transmitting data packets out of the transmit queue;
placing a data transmit function of the NDA in a sleep mode for a period of time equal to the sleep time; and
retransmitting the data packet from the NDA to the network adapter when the sleep time expires.

9. The computer program product of claim 8, further comprising program code for:
issuing a data transfer call to the network adapter via a transmit routine of the NDA;
monitoring for a return message indicating success or failure of the data transfer call; and
completing said generating of the ioctl only when the return message indicates an error of the data transfer call.

10. The computer program product of claim 8, wherein said code for determining further comprises code for:
calculating an available space remaining in the transmit queue;
determining a current rate of evicting pending data packets from the transmit queue;
evaluating an amount of space necessary to receive the data packet from the NDA into the transmit queue; and
calculating the sleep time using the results of said calculating, determining and evaluating steps along with a transmit latency for transmitting the data packet from a socket of the NDA to the transmit queue of the network adapter.

11. The computer program product of claim 10, further comprising code for:
determining if the available space within the transmit queue is large enough to hold a smaller data packet supported by the network adapter and the NDA;
when the available space within the transmit queue is large enough to hold a smaller data packet, breaking a low priority data packet into smaller data packets of similar size to the smaller data packet supported by the network adapter and the NDA;
immediately transmitting said smaller data packets to said transmit queue; and
adjusting the sleep time calculated for normal sized data packets to account for the transmission of said smaller data packets, wherein higher priority packets are held until expiration of the adjusted sleep time.

12. The computer program product of claim 8, wherein said NDA is a first NDA and said data processing system comprise multiple NDAs, said program code further comprising code for:
when at least one other NDA is actively transmitting data packets concurrently with the first NDA, calculating a unique sleep time for each of the active NDAs transmitting data packets, such that each active NDA sleeps for a different period of time to prevent conflicts when retransmitting their respective data packet(s) to the transmit queue.

13. The computer program product of claim 12, further comprising code for:
prioritizing said active NDAs relative to each other based on application provided criteria and user defined criteria; and
calculating and assigning the unique sleep time based on a relative priority of the first NBA to the other NDA.

14. The computer program product of claim 10, further comprising code for:
receiving a sendto routine from the network adapter's device driver, wherein said sendto routine includes the value of the currently available space within the transmit queue; and
periodically issuing a request for a return of said sendto routine to check the current value and adjust a new calculation of sleep time for a subsequent request to transmit data that results in an error.

15. A data processing system comprising:
a processor and memory;
a network adapter having an associated device driver and transmit queue for queuing data packets to be transmitted to an external network via the network adapter;
means for coupling the processor and memory to the network adapter;
an operating system providing software support for operation of the processor and the network adapter;
a network dependent application (NDA) than executes on processor and generates data packets that are transferred to the transmit queue for scheduling to be transmitted to the external network; and
network device feedback system that enhances packet transfer operations between the NDA and the transmit queue via a series of processes including:
when a request from the NDA to the network adapter to transmit a data packet returns an error indicating the transmit queue of the network adaptor is fall, generating an ioctl request and issuing said ioctl request to the network adapter, wherein said ioctl request triggers the network adapter to determine and return a value of a current available space within the transmit queue;
automatically determining a sleep time for the NDA based on the value of the current available space of the transmit queue and the rate at which the network adapter is currently transmitting data packets out of the transmit queue;
placing a data transmit function of the NDA in a sleep mode for a period of time equal to the sleep time; and
retransmitting the data packet from the NDA to the network adapter when the sleep time expires.

16. The data processing system of claim 15, said network device feedback system further enhancing the NDA to complete the functions of:
issuing a data transfer call to the network adapter via a transmit routine of the NDA;
monitoring for a return message indicating success or failure of the data transfer call; and
completing said generating of the ioctl only when the return message indicates an error of the data transfer call.

17. The data processing system of claim 15, wherein said determining process is completed by said network device feedback system and further comprises:
calculating an available space remaining in the transmit queue;
determining a current rate of evicting pending data packets from the transmit queue;
evaluating an amount of space necessary to receive the data packet from the NDA into the transmit queue; and
calculating the sleep time using the results of said calculating, determining and evaluating steps along with a transmit latency for transmitting the data packet from a socket of the NDA to the transmit queue of the network adapter.

18. The data processing system of claim 17, said network device feedback system farther enhances the NDA to complete the functions of:
determining if the available space within the transmit queue is large enough to hold a smaller data packet supported by the network adapter and the NDA;
when the available space within the transmit queue is large enough to hold a smaller data packet, breaking a low priority data packet into smaller data packets of similar size to the smaller data packet supported by the network adapter and the NDA;
immediately transmitting said smaller data packets to said transmit queue; and
adjusting the sleep time calculated for normal sized data packets to account for the transmission of said smaller data packets, wherein higher priority packets are held until expiration of the adjusted sleep time.

19. The data processing system of claim 15, wherein said NDA is a first NDA and said data processing system comprise multiple NDAs, said network device feedback system further completing the functions of:
when at least one other NDA is actively transmitting data packets concurrently with the first NDA, calculating a unique sleep time for each of the active NDAs transmitting data packets, such that each active NDA sleeps for a different period of time to prevent conflicts when retransmitting their respective data packet(s) to the transmit queue;
prioritizing said active NDAs relative to each other based on application provided criteria and user defined criteria; and
calculating and assigning the unique sleep time based on a relative priority of the first NBA to the other NDA.

20. The data processing system of claim 10, said network device feedback system further enhancing the network adapter's device driver to complete the functions of:
when an ioctl is received from the NDA, automatically generating a sendto routine, wherein said sendto routine includes the value of the currently available space within the transmit queue;
forwarding said sendto routine to the NDA from which the ioctl was received; and periodically issuing a new sendto routine to provide the current value and adjust a calculation of a new sleep time for a subsequent request to transmit data that results in an error.
